(19) United States
(12) Patent Application Publication
(10) Pub. No.: US 2021/0327423 A1
(43) Pub. Date: Oct. 21, 2021

(54) METHOD AND SYSTEM FOR MONITORING CONTENT OF A COMMUNICATION SESSION OVER A NETWORK

(71) Applicant: CenturyLink Intellectual Property LLC, Broomfield, CO (US)

(72) Inventors: Megan Dudley, Broomfield, CO (US); Stephen Opferman, Denver, CO (US)

(21) Appl. No.: 17/200,386

(22) Filed: Mar. 12, 2021

Related U.S. Application Data
(60) Provisional application No. 63/010,393, filed on Apr. 15, 2020.

(51) Int. Cl. G10L 15/22; G10L 15/26; G10L 25/57

(52) U.S. Cl. CPC G10L 15/22; G10L 2015/225; G10L 25/57; G10L 15/26

(57) ABSTRACT

A method is disclosed for obtaining real-time inputs from participants to an occurring via one or more computing devices, comparing the inputs to one or more profiles to detect potential biases or stereotypes in the participant's communications, and providing a potential bias alert to a participant device. The participants to the interaction may communicate via a communications network, including computing devices configured to capture various inputs from the participants in real time, such as eye movements, facial expressions, auditory responses, word choices or vocabulary, and other physical or auditory inputs. The monitoring system may receive the participant inputs and compare the inputs to one or more profiles maintained by the monitoring system. The profiles provide a decision tree of inputs and resulting intervention actions to execute. Upon the occurrence of a triggering action as determined by the selected profile, the monitoring system may execute an intervention to correct said biases.

### CROSS-REFERENCE TO RELATED APPLICATION

This application is related to and claims priority under 35 U.S.C. § 119(e) from U.S. Patent Application No. 63/010,393, filed Apr. 15, 2020 entitled “BIAS DETECTION AND CORRECTION TOOL,” the entire contents of which is incorporated herein by reference for all purposes.

### TECHNICAL FIELD

Embodiments of the present invention generally relate to systems and methods for implementing a communication monitoring system, and more specifically for a system to monitor communications between participants and provide alerts and/or interventions when instances of biases and/or stereotypes are detected in a participant's communications.

### BACKGROUND

Bias, often unintended and unconscious, can be a barrier to effective communication. Similarly, stereotypes, word choice, slang, and the like can impact communication. Many people are unaware of actions and/or particular words used in a conversation that may negatively affect how a listener receives communications. Such issues may have unique significance in a business setting whether between peers or where a power dynamic may exist. Raising awareness of the various issues, whether implicit bias or otherwise, in one's communication style may be beneficial for a number of reasons. Further, suggestions on correcting or adjusting activities (facial expressions and other bodily movements) and vocabulary may guide participants to a more effective communication style. It is difficult for direct consulting on these topics particularly when large numbers of people are involved. Moreover, in many instances the sort of communications where bias may be detected are often not uncovered in such consulting endeavors.

It is with these observations in mind, among other, that aspects of the present disclosure were conceived.

### SUMMARY

One aspect of the present disclosure relates to a communication monitoring system comprising a computing device in communication with a non-transitory storage medium including computer executable instructions. The computer executable instructions may be operable to access a bias-detecting profile and generate a string of text data based on audio information of a participant to an interaction. The instructions may further be operable to process the string of text data by the bias-detecting profile to receive an indication of a detected bias based on the string of text data and transmit, to a participant device and based on the indication of the detected bias, a bias-detection notification for display on a display device of the participant device.

Another aspect of the present disclosure relates to a method for controlling communications over a network. The method may include the operations of converting, at a communications monitoring device, an audio portion of an interaction to a string of text data, the audio portion received from a participant device to the interaction and obtaining, based on receiving the audio portion from the participant device, a bias-detecting profile. The method may also include the operations of inputting at least a portion of the string of text data to the bias-detecting profile to receive an indication of a detected bias in the audio portion and transmitting, to the participant device and based on the indication of the detected bias, a bias-detection notification for display by the participant device.

Yet another aspect of the present disclosure related to a tangible, non-transitory, computer-readable media having software encoded thereon. The software may be, when executed by a processor, operable to perform any of the operations described herein.

### BRIEF DESCRIPTION OF THE DRAWINGS

The foregoing and other objects, features, and advantages of the present disclosure set forth herein should be apparent from the following description of particular embodiments of those inventive concepts, as illustrated in the accompanying drawings. The drawings depict only typical embodiments of the present disclosure and, therefore, are not to be considered limiting in scope.

FIG. 1 is a schematic diagram illustrating a system for monitoring communications between participants in accordance with one embodiment.

FIG. 2 is a schematic diagram illustrating a participant computing device to obtain a participant's communications in accordance with one embodiment.

FIG. 3 is a schematic diagram illustrating a monitoring system for receiving communication data of participants and analyzing the communication data for instances of biases in accordance with one embodiment.

FIG. 4 is a flowchart illustrating a method for a monitoring system to receive communication data of participants and analyze the communication data for instances of biases in accordance with one embodiment.

FIG. 5 is a flowchart illustrating a method for a monitoring system to process communication data of various participants and transmit an intervention upon detection of a bias in accordance with one embodiment.

FIG. 6 is a diagram illustrating an example of a computing system which may be used in implementing embodiments of the present disclosure.

### DETAILED DESCRIPTION

Systems and methods are described herein to provide a solution for programmatically monitoring communications and detecting instances of bias, improper word choice, and the like, in communications and providing an anonymized way of communicating such instances. In some instances, the anonymized and direct feedback, outside of a human consultation environment, can help avoid embarrassment and defensiveness, and provide a more effective way of communicating concerns and be an alternative format for a person to receive and adapt to prompts. In particular, the systems, devices, and methods described herein may obtain inputs, which may be real-time streams, from participants to an interaction or communication session occurring between computing devices, which either or both of may be configured to provide a stream to the system, utilize the inputs to traverse a decision structure (such as a decision tree) of one or more profiles to detect potential biases or stereotypes in the participant's communications, and provide an intervention or feedback to a participant of the interaction to potentially correct the participant's behavior. In one particular implementation, the participants to the interaction may communicate via a communications network, including computing devices configured to capture various inputs from the participants in real time. Some such inputs may include eye movements of the participants, facial expressions, auditory responses, word choices or vocabulary, and other physical or auditory inputs. To capture these inputs from the participants, the participant devices may include audio capturing devices, such as a microphone, and/or image capturing devices, such as a video camera. Each participant device may capture the real-time inputs from the corresponding participant to the interaction and provide the inputs to a central monitoring system for processing to detect potential biases or stereotypes in a participant's inputs. In another implementation, the participant device may process the participant inputs for bias detection. Further, the monitoring system and/or participant devices may monitor and process reactions from participants receiving communications or otherwise not speaking to determine a reaction to a speaker's inputs to further detect potential bias in the speaker's communications.

In some instances, the communication platform may be one in which participants connect for a phone conference, video conference or the like, and participants may choose, such as through a user interface for the conferencing system, to have their communications analyzed and to receive feedback. The system may use a microphone and video camera of the computing device through which a user accesses the communication system to capture communications. In such a case and in similar arrangements, the system may provide the communication platform itself as well as provide the stream and other inputs to the bias detecting module (e.g., a detecting profile or trained machine learning module) and provide the analysis to the user. In such a situation, the system may maintain the anonymity of the user, the anonymity of results, or the like. The system may also be an opt-in situation for interested participants.

As mentioned, the participant inputs during the communication session may be accessed by a central monitoring system. In real-time situations, the inputs may be a stream of communication data as well as any other associated data. In a non real-time situation, the stream of data and associated data may be temporarily stored and accessed by the system. In some instances, the monitoring system may include a device or devices within a network, such as an application server or other networking device, by which the participant data may be accessed. The monitoring system may receive the participant inputs and compare the inputs to one or more profiles maintained by the monitoring system. For example, the monitoring system may maintain generic profiles for use in analyzing received communications for large groups of potential participants and/or individual profiles for use in analyzing communications from particular users of the system. In some instances, the profile may include a trained machine learning model, which may be trained using word data, image data and the like. The monitoring system may receive one or more identifying characteristics of the participants of the interaction to select which profile to use to analyze the participant's inputs. For example, the monitoring system may select a generic profile for a participant based on the participant's age, gender, nationality, or other identifiers obtained from an analysis of the participant's inputs or from log-in information provided to the monitoring system by the corresponding participant device. In another example, the monitoring system may select an individual profile from inputs provided to the participant device. The information used to select the profile or profiles for an interaction may be encrypted or otherwise securely stored such that access to the profiles is limited to the monitoring system and/or the participant devices of the communication system.

In general, the profiles provide a decision tree or other decision structure of potential participant inputs and resulting intervention actions to execute upon the occurrence of a triggering action. During an interaction, the monitoring system or participant devices may compare the real-time inputs to the selected profiles. Application of the inputs to the profiles may cause the monitoring system to traverse the decision tree of the profile. Upon the occurrence of a triggering event, such as the detection of a use of a bias word, action, negative reaction from a listener, etc., the profile may return an intervention action to the monitoring system for execution. The triggering event may include any combination of participant inputs and, in some instances, include one or more threshold values. For example, repeated use of a word or phrase by a participant may trigger the response, while a single use of the same word or phrase may not. One or more time limits may also be included in the profile decision tree threshold values. In some instances, triggering events may be severity weighted reflecting that not all triggering events have the same effect—some being particularly subtle and others being particularly egregious. Upon the occurrence of a triggering action as determined by the selected profile, the monitoring system may execute an intervention. In one example, the intervention may cause the monitoring system to transmit a notification to a participant's device. The notification may be displayed on a display of the participant's device with instructions to the participant on how to correct the participant's communication style to avoid the detected bias. Other interventions may include providing a report to a participant upon completion of the interaction with analysis of the participant's communications and suggested improvements. In this manner, the communication system may detect potential biases in communications during an interaction and provide interventions to correct said biases.

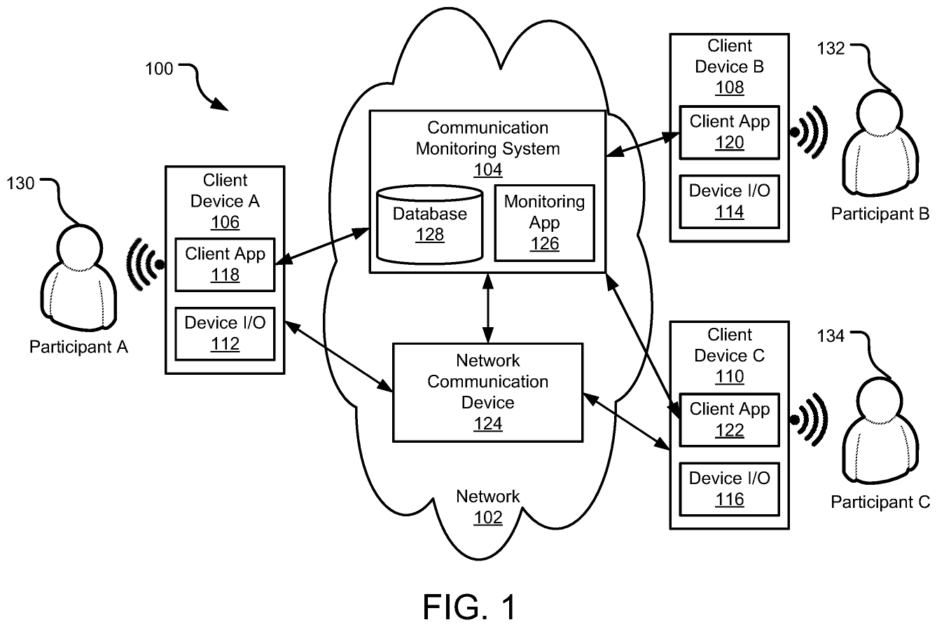

Beginning in FIG. 1, a schematic diagram illustrating a system 100 for monitoring communications between participants in accordance with one embodiment is shown. In some implementations, the system 100 may receive inputs from one or more participants to an interaction or communication session, compare the received inputs to one or more profiles to determine a potential instance of ineffective communication between the participants, and execute an intervention action in response to the detected ineffective communication instance. In one particular example, the ineffective communication may include an instance of bias or stereotyping by a speaker in the interaction. However, although generally described herein as related to bias, other forms of ineffective communication may also be detected by the system, such as instances of misunderstanding, instances of mumbled speech, instances of negative reactions to particular words or phrases, and the like. The system 100 may include more or fewer components than shown in FIG. 1 and the illustrated components are but one possible implementation of the system and components.

In general, the system 100 may include a monitoring system 104 in communication with one or more client or participant devices 106-110. In the instance illustrated in system 100, monitoring system 104 is in communication with client device A 106, client device B 108, and client device C 110. The client devices 106-110 may be a computing device through which communications may be transmitted to a user. For example, client device A 106 may be used by participant A 130 to transmit communications to monitoring system 104. In addition, the client devices 106-110 may exchange communications with other client devices via telecommunications network 102. For example, client device A 106 may communicate with client device C 110 via network device 124. Network device 124 may be a network device 124 configured to route communications between client devices 106-110. In one particular instance, the network device 124 may be a conference call platform hosted by the network 102 for facilitating communications between multiple parties at once, such as between client device A 106, client device B 108, and client device C 110. In some instances, monitoring system 104 may similarly be a party to a conference call hosted by network communication device 124 to receive the communications shared between the client devices 106-110.

In general, any type of communication interaction between the client devices 106-110 may occur via network 102 that provides for participant A 130, participant B 132, and participant C 134 to exchange communications. Such communications may include multimedia components, such as a video component of the participants and surrounding environment, an audio component of the participant's voice and surrounding environment, and/or images of the participants. As such, each of the client devices 106-110 may include one or more input/output (I/O) devices 112-116 configured as sensor to obtain audio data, video data, image data, biometric data, and the like from the participants 130-134. As such, the client devices 106-110 may be computing devices capable of transmitting communication packets via a network 102 that include multimedia data. For example, the client devices 106-110 may be a personal computer, laptop computer, smart phone, tablet device, personal assistant device, desk telephone with video and audio capabilities, and the like. To exchange the multimedia communications, the participants 130-136 may activate an application or other software configured to communicate with network 102 and/or network communication device 124, establish a connection with the network communication device 124, capture multimedia data or other inputs from the corresponding participant 130-136, convert the captured data into packets, and transmit the converted packets to the network communication device 124. The network communication device 124 may receive the multimedia packets from the client devices 106-110 and route the packets to a destination device. In this manner, the network communication device 124 may facilitate the exchange of the multimedia packets between the client devices 106-110 during an interaction or communication session between the devices.

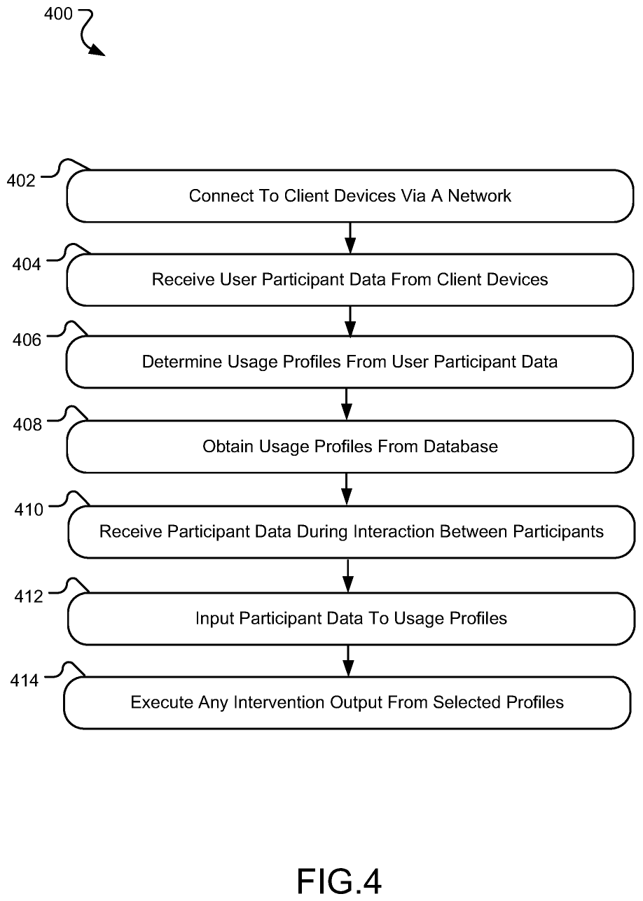

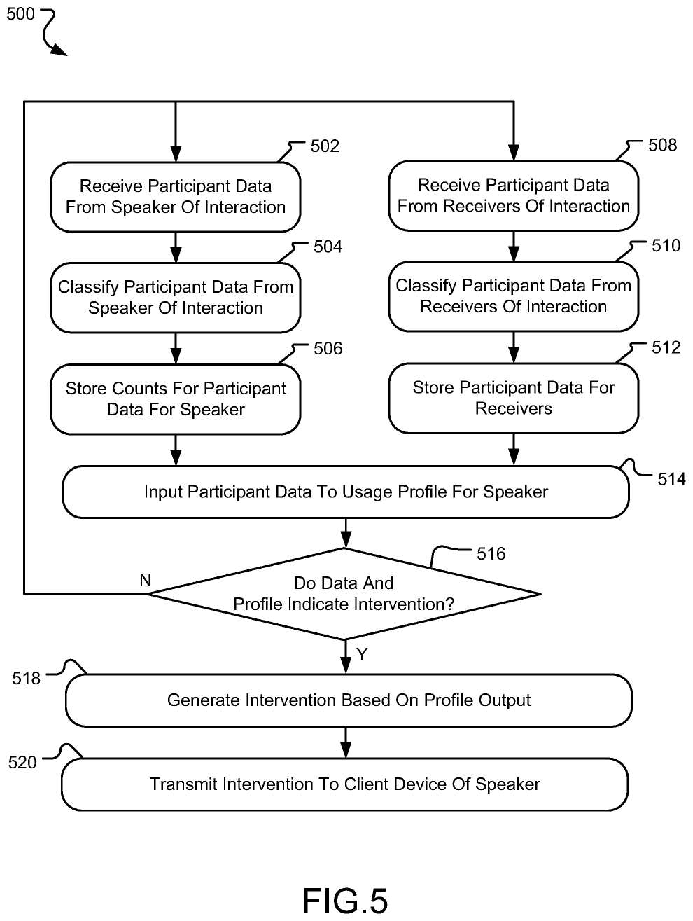

As mentioned above, the client devices 106-110 and/or the network communication device 124 may transmit the multimedia packets of the interaction to a monitoring system 104 associated with the network 102. The monitoring system 104 may be a part of network 102 or may be separate from the network. In one particular example, the monitoring system 104 may be an application server device within network 102 such that monitoring system 104 may receive multimedia packets, communications, or other data packets from client devices 106-110 connected to network 102. To transmit interaction data to monitoring system 104, client devices 106-110 may execute a client application 118-122 configured to obtain user input data, such as video and/or audio data of the corresponding participant 130-134. The client applications 118-122 may obtain the user input data from the I/O devices 112-116 of the client device 106-110. The client applications 118-122 may packet the user input data into transmission packets and transmit the packets to network 102 with an identification of the monitoring system 104 as a destination device. The monitoring system 104 may execute a control application 126 to receive the participant inputs and process the inputs to identify an ineffective communication instance within the participant interactions. The operations of the control application 126 are described in more detail below with reference to FIGS. 4 and 5.

In another implementation, the monitoring system 104 may communicate with network communication device 124 to obtain one or more use inputs from the client devices 106-110. For example, the network communication device 124 may be a conference hosting bridge exchanging communications between the client devices 130-134 during a conferencing call. The monitoring system 104 may, in some instances, become a participant to the conference call and receive the multimedia packets exchanged between the client devices 106-110 during the conference call. The control application 126 may analyze the exchanged multimedia packets to identify one or more instances of an ineffective communication between the participants, such as instances of bias or stereotyping by one of the participants. In this implementation, the client devices 106-110 may not transmit the user inputs directly to the monitoring system 104, which may reduce processing strain on the network 102.

Upon receiving user inputs from the participants 130-134, the control application 126 may compare or apply the user inputs to one or more communication profiles maintained by the monitoring system 104 to determine instances of ineffective communication. As explained in more detail below, the monitoring system 104 may include a database 128 storing profiles for use in identifying ineffective communication during a communication session. In some instances, the stored profiles may be encrypted or otherwise securely stored to prevent devices other than the monitoring system from accessing the profiles. In other instances, the profiles may be stored in a database separate from the monitoring system 104 and accessed during interactions between the participants. Further still, the network 102 may include a plurality of such monitoring systems 104, with each monitoring system accessing a central database of profiles for use in identifying ineffective communications. The profiles of the database 128 may be generated by the monitoring system 104 based on previous interactions and inputs received at the monitoring system 104 from a user through an associated client device or from another computing device. For example, the monitoring system 104 may store the user input data from several previous interactions and process the input data to generate a decision tree or other structure that identifies an ineffective communication between the participants. In another example, the monitoring system 104 may receive a profile from a third party device and store the profile in the database 128 for use in identifying ineffective communications during an interaction. Generation of the profiles for storage in the database 128 is explained in more detail below.

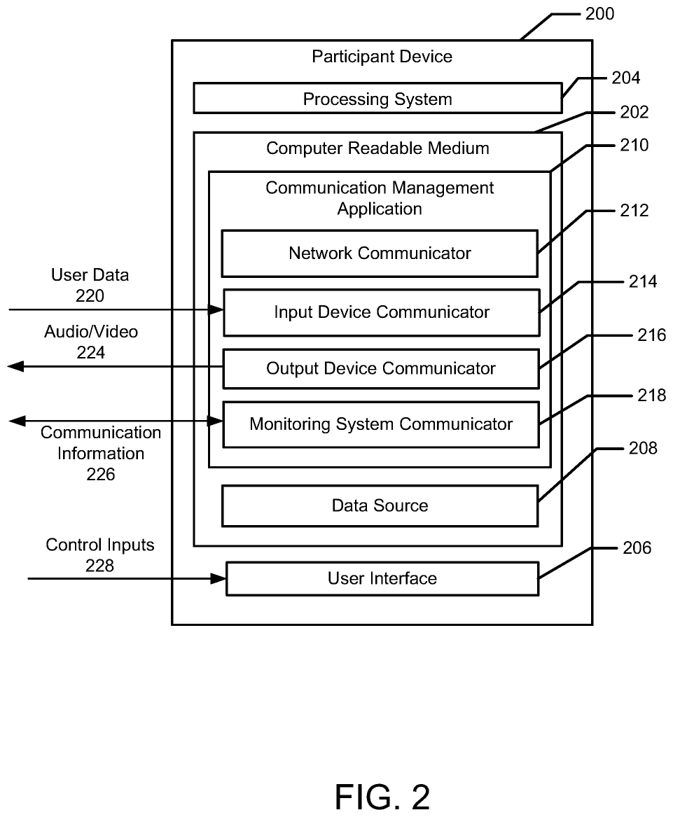

As mentioned, the client devices 106-110 may connect to the network 102 to exchange multimedia packets and/or user input data using a client application 118-122. FIG. 2 is a schematic diagram illustrating a participant or client device 200 for managing user inputs during a communication interaction between participants. The participant device 200 of FIG. 2 may be the client device 106-110 discussed above. In some instances, a communication management application 210 may be executed on the participant device 200 to perform one or more of the operations described herein. The communications management application 210 may be stored in a computer readable media 202 (e.g., memory) and executed on a processing system 204 of the participant device 200 or other type of computing system, such as that described below. The computer readable medium 202 includes volatile media, nonvolatile media, removable media, non-removable media, and/or another available medium. By way of example and not limitation, non-transitory computer readable medium 202 comprises computer storage media, such as non-transient storage memory, volatile media, nonvolatile media, removable media, and/or non-removable media implemented in a method or technology for storage of information, such as computer readable instructions, data structures, program modules, or other data.

According to one embodiment, the participant device 200 may also provide a user interface (e.g., a command line interface (CLI), a graphical user interface (GUI), etc.) 206 displayed on a display, such as a computer monitor, for displaying data. Through the user interface 206, a user of the participant device 200 may provide control inputs 228 through one or more input devices. The control inputs 228 may include log-in information for accessing the communication analysis system 100 described above, inputs to connect to a communication interaction (such as a video conference call), inputs to interact with a communication interface, inputs responding to an intervention activity, and the like. The input device for providing the control inputs 228 may include, among others, a keyboard or a pointing device (e.g., a mouse, trackball, pen, or touch screen) to enter data into or interact with the user interface 306.

The communication management application 210 may also utilize a data source 208 of the computer readable media 202 for storage of data and information associated with the participant device 200. For example, the communication management application 210 may store information associated with the management of communications by the participant device 200, including user input data obtained from one or more sensors (such as a video camera, microphone, eye tracker, and the like), participant identification information (such as log-in information, user names, biographical data, etc.), information for facilitating a communication interaction (such as a telephone number associated with the participant device 200), and the like. In general, any data or information utilized by the communication management application 210 may be stored and/or retrieved via the data source 208.

The communication management application 210 may include several components to perform one or more of the operations described herein. For example, the communication management application 210 may include a network communicator 212 for packaging user inputs and other information into packets for transmission to a communication network 102. The network communicator 212 may therefore prepare and transmit information and/or data to the network 102 and receive data packets from the network. Through the network communicator 212, the participant device 200 may communicate with the monitoring system 104 for analyzing communications of a participant using the participant device 200 to communicate with other participant devices.

The communication management application 210 may also include an input device communicator 214 for communicating with one or more sensors or input devices of the participant device 200. For example, the participant device 200 may communicate with input devices configured to obtain audio or visual data on a participant, such a video camera, a microphone, an eye movement tracker, a speech-to-text translator, and the like. These input devices may receive or obtain audio and/or video data of the corresponding participant to the participant device 200 and provide this user data 220 to the input device communicator 214. The input device communicator 214 may provide the user data 220 to the network communicator 212 and/or the monitoring system communicator 218 for transmission to the monitoring system 104 for processing. The communication management application 210 may also include an output device communicator 216 for communicating with one or more output devices, such as a speaker or a display device. The output device communicator 216 may receive information or data 226 from the monitoring system communicator 218 and/or the network communicator 212 for output to the participant of the participant device 200. Such audio/video data 224 may be displayed on the output display device or speaker for presentation to the participant.

The communication management application 210 may also include a monitoring system communicator 218 for transmitting and receiving communications 226 with the monitoring system 104. For example, the monitoring system communicator 218 may transmit the user data 220 to the monitoring system 104 for processing or analysis to detect ineffective communication, such as instances of biases or stereotypes, in the communications between participants. The monitoring system communicator 218 may also receive interventions from the monitoring system 104. For example and as explained detail below, the monitoring system 104 may transmit a message or text to the participant device 200 for display on a user interface 206 that provides an indication of a detected bias in the participant's speech and may provide a suggested remedy or adjustment in response to the detected bias. In this manner, the monitoring system communicator 218 may also communicate with the user interface 206 and/or the output device communicator 216 to display the intervention message.

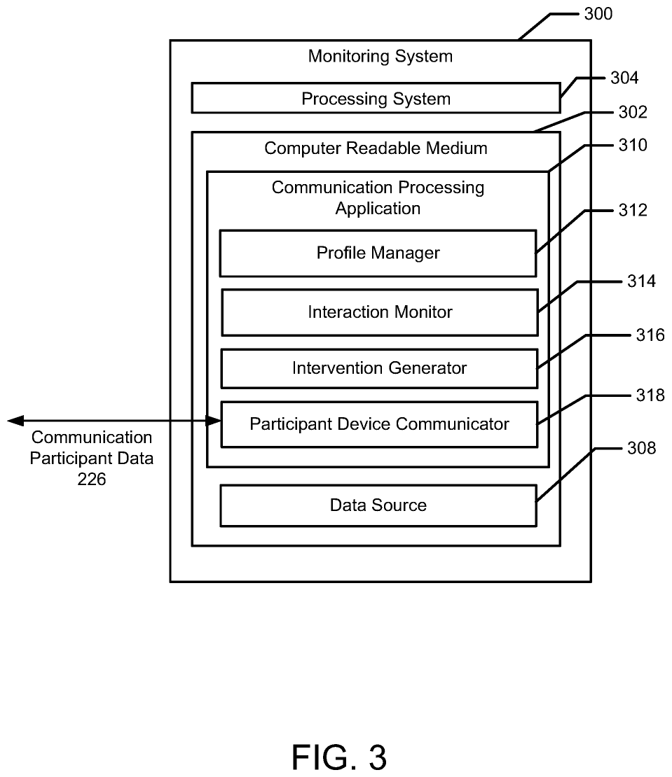

FIG. 3 is a schematic diagram illustrating a monitoring system 300 for receiving communication data of participants and analyzing the communication data for instances of biases in accordance with one embodiment. The monitoring system 300 of FIG. 3 may be the monitoring system 104 discussed above. In some instances, a communication processing application 310 may be executed on the monitoring system 300 to perform one or more of the operations described herein. The communications processing application 310 may be stored in a computer readable media 302 (e.g., memory) and executed on a processing system 304 of the communication system 300 or other type of computing system, such as that described below. The computer readable medium 302 includes volatile media, nonvolatile media, removable media, non-removable media, and/or another available medium. By way of example and not limitation, non-transitory computer readable medium 302 comprises computer storage media, such as non-transient storage memory, volatile media, nonvolatile media, removable media, and/or non-removable media implemented in a method or technology for storage of information, such as computer readable instructions, data structures, program modules, or other data.

The communication processing application 310 may also utilize a data source 308 of the computer readable media 302 for storage of data and information associated with the monitoring system 300. For example, the communication processing application 310 may store information associated with the processing of communication data by the participants of an interaction, including participant data obtained from one or more sensors of a participant device (such as a video camera, microphone, eye tracker, and the like), participant identification information (such as log-in information, user names, biographical data, etc.), analysis profiles comprising decision trees or other structures for detecting potential biases in the participant data, and the like. In general, any data or information utilized by the communication processing application 310 may be stored and/or retrieved via the data source 308.

The communication processing application 310 may include several components to perform one or more of the operations described herein. For example, the communication processing application 310 may include a profile manager 312 for managing one or more profiles of ineffective communications. As explained in more detail herein, the profiles may include a decision tree or other structure that receives participant inputs during an interaction between the participants. For example, analysis of eye tracking of a participant may indicate a participant rolling their eyes or looking away from a camera's location. The participant eye movements may be input into a profile to traverse the decision tree toward one or more intervention actions. In another example, a speech to text program of the monitoring system 300 may translate audio inputs received participants into a series of words. The translated words and/or groups of words (e.g., phrases) may also be input into a profile to traverse the decision tree within the profile. In general, any participant data may be applied or input into a profile for processing and determination of a potential ineffective communication by a participant.

The ineffective communication profiles may be generated in a variety of ways. In one instance, the profiles may be generated by a third party system and provided to the monitoring system 300 for storage in the data source 308. In another instance, the profile manager 312 may generate one or more of the profiles used by the system 300. For example, through analysis of multiple participant interactions, the monitoring system 300 may generate a decision tree for one or more profiles based on participant reactions or feedback in which a participant exhibits a bias or other inefficient communication. Upon the detection of a bias based on participant reactions or feedback, the profile manager 312 may generate a grouping of participant data that led up to the bias occurrence. For example, the profile manager 312 may determine that a particular word or phrase triggered the participant reaction such that the word may be perceived as bias or another form of ineffective communication. The identified word may be included in a profile. During an interaction, an utterance of the word in the participant input may cause the profile to return a detection of a potential bias in a participant's speech and, in some instances, may trigger an intervention action. Analysis of multiple interactions, perhaps through machine learning algorithms or other data analysis algorithms, may refine, grow, amend, or the like the profiles managed by the profile manager 312. For example, through the analysis of multiple interactions, the profile manager 312 may detect a series of words, phrases, and physical movements of a participant that elicit a negative reaction from a listener. This series of participant data may be included in one or more profiles for use by the monitoring system 300 to identify potential bias or other ineffective communication by a participant.

Further, different profiles may be stored and/or selected for use by the profile manager 312, in some instances based on an identification of the participants to the interaction. For example, each participant to an interaction may have an associated profile generated based on the participant's speech patterns, word usages, physical movements, and the like. Similar to above, the personal profile may be generated from analysis and/or processing of multiple previous interactions by the participant. In some instances, the personal profile may be encrypted or otherwise stored or maintained in a secure manner such that access to a personal profile is limited to approved devices, such as monitoring system 300. In another example, the profile may a generic or global profile for application to multiple potential participants of the communication system 100. For example, the monitoring system 300 may utilize a generic profile for all participants to an interaction. In another example, profiles for participants from a particular region (such as a country, state, city, etc. in which the participant resides), profiles for participants based on the participant's biographical information (such as a participant's age, race, sex, etc.), profiles based on a participant's company or employer, and the like. In general, the profile manager 312 may select any number of profiles may be utilized by the monitoring system 300 based on any characteristic of the participants of the interaction. Selection of the profiles for use in an interaction is discussed in more detail below with reference to method 400 of FIG. 4.

The communication processing application 310 may also include an interaction monitor 314 for monitoring participant inputs during an interaction between the participants. For example, the interaction monitor 314 may process received audio portions of interactions between the participants, such as by converting the audio portions into text or other format that may be input to a profile. In some instances, the interaction monitor 314 may parse the received participant inputs to identify particular keywords for input to the profile. For example, the profile may include a list of keywords for input to traverse the decision tree of the profile. The keywords may be provided to the interaction monitor 314 for searching by the monitor during an interaction. In another example, the interaction monitor 314 may process received video data to detect particular movements of a participant, such as eye movements, facial movements, hand gestures, and the like. One or more of the participant's physical movements may also be provided to a profile to detect ineffective communication between the participants during the interaction. In some instances, the interaction monitor 314 may be programmed to identify particular eye movements, facial expressions, word choices, phrases, and the like and provide instances of the identified participant data to the profile manager 312 upon occurrence. Such reporting may include an identification of the participant to which the associated data was extracted for application to the one or more profiles for the interaction.

As mentioned above, an output of a profile may be an indication of a detected bias or other ineffective communication during the interaction of the participants. In some instances, the output may be provided to an intervention generator 316 of the communication processing application 310. The intervention generator 316 may generate a type of intervention to transmit to a participant device 200. For example, the intervention may include a text box for display on a display device of the participant device 200. In another example, the intervention may include an audio cue for playing on the participant device 200 to alert the participant to the intervention. In general, the intervention may be configured to alert the participant to the output of the profile and a detected ineffective communication by the participant, such as through a detected bias. The intervention generator 316 may provide the intervention to a participant device communicator 318 of the communication processing application 310. The participant device communicator 318 may transmit to and receive communications from the participant devices 200 to an interaction. The communication participant data 226 may include obtained video/audio of the participants during an interaction received at the participant device communicator 318 and instructions for executing an interaction at the participant devices 200 transmitted from the participant data communicator. The participant data communicator 318 may therefore manage all communications between the monitoring system 300 and the participant devices 200 of the interaction.

It should be appreciated that the components described herein are provided only as examples, and that the communication management application 210 of the participant device 200 and/or the communication processing application 310 of the monitoring system 300 may have different components, additional components, or fewer components than those described herein. For example, one or more components as described in FIGS. 2 and/or 3 may be combined into a single component. As another example, certain components described herein may be encoded on, and executed on other computing systems.

As mentioned above, the monitoring system 300 may receive participant data of an interaction and analyze the data for instances of biases or other ineffective communications by the participants. FIG. 4 is a flowchart illustrating a method 400 for a monitoring system 300 to receive participant data of an interaction and analyze the data for instances of biases or other ineffective communications by the participants in accordance with one embodiment. In one instance, the operations of the method 400 of FIG. 4 may be executed or performed by a monitoring system, such as monitoring system 104 of communication system 100. However, one or more of the operations may be performed by other components of the communication system 100, such as client devices 106-110. The operations may be executed through hardware components, software programs, or a combination of hardware and software components.

Beginning in operation 402, the monitoring system 104 may connect to one or more client devices 106-110 associated with participants to an interaction to begin receiving participant data from the client devices. Connection to the client devices 106-110 may occur over a wired or wireless network 102. In general, the connection between the monitoring system 104 and the client devices 106-110 may support multimedia communications, in some instances supporting 4k or other high-definition video and/or audio signals. The connection between the monitoring system 104 and the client devices 106-110 may therefore be any connection that allows for exchange of communications between the devices. In one particular instance, the monitoring system 104 may connect to the client devices 106-110 via a network communication device 124, such as a conference hosting device. For example, the monitoring system 104 may connect to a conferencing platform hosting a conference of the participating devices, such as a phone conference, video conference, and the like. Further, the participants may choose, such as through a user interface to the conferencing system displayed on a corresponding participant device, to have their communications monitored, analyzed, and to receive feedback on the analyzed communications. In this manner, the monitoring of communications may be an opt-in situation for participants interested in the service. As further explained herein, the participant's communications, identities, and selections may be securely maintained to prevent a third party from accessing such information.

Regardless of the type of connection utilized, the monitoring system 104 may begin receiving participant data from the client devices 106-110 in operation 404. For example, the monitoring system 104 may receive video data and/or audio data of a participant 130-134 using a participant device 106-110 obtained from one or more I/O devices 112-116 associated with the participant's client device. The monitoring system 104 may also receive identification data of a participant 130-134, such as log-in credentials, password information, conference call information, etc. In some instances, the monitoring system 104 may also analyze the participant data to determine one or more characteristics of the participants 130-134. For example, the monitoring system 104 may use facial recognition technology, compare the facial images to a database of registered users of the system 100, and identify one or more participants based on the facial image of the participant. In another example, the monitoring system 104 may obtain a voiceprint of a participant to identify the participant from a database of registered participants based on the voiceprint. Other identifying information may also be obtained from the participant data, such as biological characteristics of the participants from a database of participant information, geographic location of a participant, associated company or employer of the participant, personality information of a participant, and the like. In general, any information of a participant may be received or obtained by the monitoring system 104 in response to participant data.

In operation 406, the monitoring system 104 may utilize the participant information to select or determine one or more ineffective communication profiles for use during an interaction between the participants. As explained above, the monitoring system 104 may include generic and/or personal profiles for use in identifying instances of ineffective communication, such as occurrences of bias by a speaker. The profiles may be selected by the monitoring system based on information obtained about the participants to the interaction. In some instances, the monitoring system 104 may select more than one profile to use for an interaction. Any participant information may be utilized in selecting a profile. For example, a participant's log-in information may be used to select a personal profile for application during the interaction. In another example, a participant's estimated geographic location may be used to select a profile for application to that participant. In still another example, a generic profile may be selected and used for all participants to the interaction. Further still, a personal profile may be used for a first participant, 130, a universal or generic profile may be used for a second participant 132, and a third profile based on a participant's race may be used for a third participant 134, all for use in the same interaction between the participants. As explained above, the ineffective communication profiles may include a decision tree or other structure, in some instances generated through a machine-learning algorithm, to determine occurrences of ineffective communication between the participants.

In operation 408, the monitoring system 104 may obtain the identified or selected profiles from a database of such profiles. In some instances, the monitoring system 104 may maintain the profiles in a data source of the monitoring system. In other instances, the profiles may be stored in a database separate from the monitoring system 104 such that the monitoring system may request the selected profiles from the separate database. In operation 410, the monitoring system 104 may receive participant data from the client devices 106-110 during the interaction between the participants. The participant data may include multimedia data, such as video and audio feeds, as well as biometric data of the participant's during the interaction. Such data may be collected by the I/O devices 112-116 of the corresponding client device 106-110 to the participant. The client devices 106-110 may package and send the participant data to the monitoring system 104 via the network 102 or via the network communication device 124. In operation 412, the monitoring system 104 may input the received participant data into the selected profiles used for the interaction. As mentioned, the profiles may accept, as an input, participant data such as words, phrases, tone, facial expressions, eye movements, and the like. Each input may cause a progression through a decision tree structure to an output. In some instances, the decision tree structure may include a threshold value, such as a number of times a particular word is uttered by a participant. The monitoring system 104 and/or profile may therefore track a number of times an input from the participant data is provided to determine when the threshold value is met or exceeded. The monitoring system 104 may also translate physical movement and/or biometric data into a quantifiable data segment for input into the profile to progress through the decision structure of the profile. In general, the monitoring system 104 may translate or alter the received participant data in any manner into a form for input into the selected profiles to obtain a potential output from the profiles.

In operation 414, the monitoring system 104 may execute any intervention outputs from the profiles based on the input participant data applied to the profile. The intervention process may include transmitting one or more instructions to a client device associated with a participant of the interaction. The instructions may cause the client device 106-110 to display or announce an intervention to the participant identified by the output of the profile. The intervention may be designed to notify the participant of a possible occurrence of ineffective communication by the participant and a suggested change in communication to rectify the occurrence or prevent future occurrence of the detected activity. In some instances, the instructions may cause the corresponding client device 106-110 to receive feedback from the participant, perhaps via a user interface or other input from the participant, acknowledging the intervention. This feedback may be transmitted to the monitoring system 104 for storage and/or to notify the monitoring system 104 to repeat one or more of the operations of the method 400 of FIG. 4.

FIG. 5 is a flowchart illustrating a method 500 for a monitoring system 104 to process participant data of various participants of an interaction and transmit an intervention upon detection of a bias or other ineffective communication in accordance with one embodiment. Similar to above, the operations of the method 500 of FIG. 5 may be performed by the monitoring system 104 of communication system 100. However, one or more of the operations may be performed by other components of the communication system 100, such as client devices 106-110. The operations may be executed through hardware components, software programs, or a combination of hardware and software components.

Beginning in operation 502, the monitoring system 104 may receive participant data from a speaker of an interaction between participants. As mentioned above, the participant data may include multimedia data, such as video and/or audio. For a speaker in the interaction, such participant data may include text data, such as spoken words or phrases as the speaker may predominantly utilize words and phrases to communicate. However, the speaker may also utilize gestures, facial expressions, and other physical cues during the interaction such that video data may also be included in the participant data. In one example, the participant data may be an eye tracking of the speaker and may detect at which other participants to the interaction the speaker is looking. In operation 504, the monitoring system 104 may classify the speaker participant data. Classification of the speaker participant data may include determining particular words or phrases for inclusion as input to a profile selected for the speaker. For example, the speaker's profile may include a list of words or phrases to be used as input to the profile. Thus, the monitoring system 104 may analyze the text data for the identified words or phrases and classify those words as input for the profile. Other words not identified by the profile may be classified as extra words and not included as input to the profiles. In other examples, the monitoring system 104 may similarly classify video or image participant data for input to the profile. For example, the monitoring system 104 may determine a length of time in which the speaker has not looked at one or more participants, a frequency at which the speaker looks at the participants, and/or a duration for which the speaker looks at each participant. This data may also be classified for input into a profile. In operation 506, the monitoring system 104 may store a count for occurrences of the identified words or visual data for input to the profile in the participant data for the speaker.

In a similar manner, the monitoring system 104 may simultaneously receive participant data for listeners or receivers of the interaction. For example, the monitoring system 104 may, in operation 508, receive participant data from one or more receivers of the speakers input of the interaction. The participant data, as they are most likely silent while the speaker is speaking, may predominantly include video or biometric data, such as facial expressions, eye movements, gestures, heartrate, etc. obtained from one or more I/O devices of the participant devices 106-110. Audio data may also be received, such as sighs, moans, or other audible inputs, may be included in the participant data. The monitoring system 104 may also, in operation 510, classify the participant data received from the receivers in the interaction. For example, the profile associated with the speaker may also include a list of visual inputs from listeners of the speaker as inputs to the profile to determine an instance of bias or other ineffective communications. Thus, the monitoring system 104 may classify the participant data of the listeners as inputs for the profile or extra movements not input to the speaker profile. In this manner, the speaker profile may indicate which visual actions by the listeners may indicate a potential bias within the speech or actions of the speaker. Such classified inputs may be stored in operation 512 for input to the profile for the speaker.

In operation 514, the stored participant data from the speaker and the listeners may be input to the profile for the speaker. As mentioned above, the input to the profile may cause a traversal through a decision tree or other structure stored by the profile to detect occurrences of bias or other ineffective communication by the speaker. Thus, in operation 516, the monitoring system 104 may determine if the profile outputs an intervention based on the input participant data of the speaker and/or the listeners to the interaction. If the profile does not output an intervention, the monitoring system 104 may return to operations 502 and 508 to collect additional participant data on the speaker and the listeners. In some instances, a new speaker of the participants may begin speaking, at which point the monitoring system 104 may obtain a profile for the new speaker and continue the process 500 of FIG. 5. The stored participant data may be maintained for the next instance of the speaker speaking for further analysis of the speaker's communications.

If the profile outputs an intervention in operation 516, the monitoring system 104 may generate an intervention in operation 518. The intervention may be based on the output from the profile. For example, the profile may output that the speaker performed a particular type of bias or ineffective communication. The monitoring system 104 may generate the intervention based on the output of the particular type of bias of the speaker. As mentioned above, the intervention may inform the speaker of the detected bias or ineffective communication and may include one or more additional steps that the speaker may take to prevent future occurrences of the detected bias. For example, the intervention may inform the speaker that she uttered a potentially biasing word seven times during the interaction, exceeding a threshold value defined by the profile and suggest to the speaker to cease uttering the identified word. In another example, the intervention may inform the speaker that she has not addressed a particular participant for 10 minutes or more and may request the speaker to address that participant. Any type of detected bias or inefficient communication as output by the profile may be profile may be identified and one or more rectifying actions may be generated by the monitoring system 104. In operation 520, one or more instructions may be transmitted to a client device associated with the speaker for execution to display or otherwise present the intervention to the speaker. In this manner, the system 100 may identify potential bias or other communication issues during an interaction of participants and provide an intervention to correct the participant's action.

Although discussed herein as applying to real-time interactions, the systems and methods may also apply to training procedures. For example, one or more of the participants to the interaction may be a recorded participant that provides preset responses to a speaker's data. The recorded actions and words of the recorded participants may therefore be played for the speaker during an interaction to train the speaker to identify potential bias or other aspects of the speaker's conversation style. Such interactions may occur, in some instances, in a virtual reality environment such that the client device 106-110 may be a virtual or augmented reality headset. Feedback in the form of the interventions may also be displayed in the virtual or augmented environment. In such an instance, audio and facial information may be recorded at speeds up to 50 khz (50,000 samples per second). The system may create a biofeedback system that is capable of identifying patterns of speech or facial expressions that correlate with positive emotion at the individual level, and give feedback to the individual on how their behaviors can be changed to increase the probability of their behaviors being perceived positively. This biofeedback system may be used as a training tool which gives feedback to users on their behaviors during conversation (i.e., it will identify and disclose behaviors, at the individual level, which are predictive of positive emotion, as well as negative behaviors which predict negative emotion).

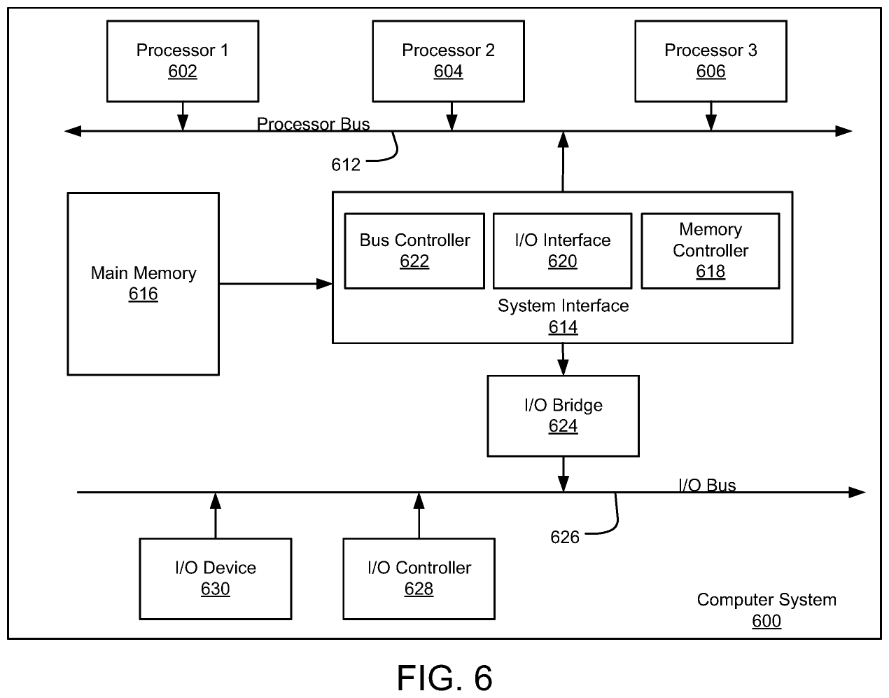

FIG. 6 is a block diagram illustrating an example of a computing device or computer system 600 which may be used in implementing the embodiments of the components of the network disclosed above. For example, the computing system 600 of FIG. 6 may be the computing device on which the simulator discussed above is executed. The computer system (system) includes one or more processors 602-606. Processors 602-606 may include one or more internal levels of cache (not shown) and a bus controller or bus interface unit to direct interaction with the processor bus 612. Processor bus 612, also known as the host bus or the front side bus, may be used to couple the processors 602-606 with the system interface 614. System interface 614 may be connected to the processor bus 612 to interface other components of the system 600 with the processor bus 612. For example, system interface 614 may include a memory controller 614 for interfacing a main memory 616 with the processor bus 612. The main memory 616 typically includes one or more memory cards and a control circuit (not shown). System interface 614 may also include an input/output (I/O) interface 620 to interface one or more I/O bridges or I/O devices with the processor bus 612. One or more I/O controllers and/or I/O devices may be connected with the I/O bus 626, such as I/O controller 628 and I/O device 630, as illustrated.

I/O device 630 may also include an input device (not shown), such as an alphanumeric input device, including alphanumeric and other keys for communicating information and/or command selections to the processors 602-606. Another type of user input device includes cursor control, such as a mouse, a trackball, or cursor direction keys for communicating direction information and command selections to the processors 602-606 and for controlling cursor movement on the display device.

System 600 may include a dynamic storage device, referred to as main memory 616, or a random access memory (RAM) or other computer-readable devices coupled to the processor bus 612 for storing information and instructions to be executed by the processors 602-606. Main memory 616 also may be used for storing temporary variables or other intermediate information during execution of instructions by the processors 602-606. System 600 may include a read only memory (ROM) and/or other static storage device coupled to the processor bus 612 for storing static information and instructions for the processors 602-606. The system set forth in FIG. 6 is but one possible example of a computer system that may employ or be configured in accordance with aspects of the present disclosure.

According to one embodiment, the above techniques may be performed by computer system 600 in response to processor 604 executing one or more sequences of one or more instructions contained in main memory 616. These instructions may be read into main memory 616 from another machine-readable medium, such as a storage device. Execution of the sequences of instructions contained in main memory 616 may cause processors 602-606 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media and may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 606 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in main memory 616, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

We claim:

1. A communication monitoring system comprising:
a computing device in communication with a non-transitory storage medium including computer executable instructions operable to:
access a bias-detecting profile;
generate a string of text data based on audio information of a participant to an interaction;
process the string of text data by the bias-detecting profile to receive an indication of a detected bias based on the string of text data; and
transmit, to a participant device and based on the indication of the detected bias, a bias-detection notification for display on a display device of the participant device.

2. The communication monitoring system of claim 1 wherein the computing device is in communication with a plurality of participant devices, the string of text data received from one of the plurality of participant devices.

3. The communication monitoring system of claim 1, the computer executable instructions are further operable to:
select the bias-detecting profile from a plurality of profiles, wherein selecting the bias-detecting profile is based on an identification of the participant to the interaction.

4. The communication monitoring system of claim 3, further comprising:
a database storing the plurality of profiles, wherein the computer executable instructions are further operable to:
request the bias-detecting profile from the database.

5. The communication monitoring system of claim 3 wherein the identification of the participant comprises log-in credentials received from the participant device.

6. The communication monitoring system of claim 1 wherein the bias-detecting profile comprises a decision tree having at least one output indicating the detected bias based on a plurality of text-based inputs.

7. The communication monitoring system of claim 1, the computer executable instructions are further operable to:
classify video data of the participant to the interaction; and
input at least a portion of the classified video data to the bias-detecting profile.

8. The communication monitoring system of claim 7 wherein the video data comprises data obtained via an eye tracking device of the participant device.

9. The communication monitoring system of claim 1 wherein generating the string of text data comprises applying a speech-to-text process to the audio information, the speech-to-text generating the string of text data from the audio information.

10. A method for controlling communications over a network, the method comprising:
converting, at a communications monitoring device, an audio portion of an interaction to a string of text data, the audio portion received from a participant device to the interaction;
obtaining, based on receiving the audio portion from the participant device, a bias-detecting profile;
inputting at least a portion of the string of text data to the bias-detecting profile to receive an indication of a detected bias in the audio portion; and
transmitting, to the participant device and based on the indication of the detected bias, a bias-detection notification for display by the participant device.

11. The method of claim 10, further comprising:
connecting the communications monitoring device to a conferencing system of a network hosting the interaction between a plurality of participant devices.

12. The method of claim 10, further comprising:
selecting the bias-detecting profile from a plurality of profiles, wherein selecting the bias-detecting profile is based on an identification of a participant to the interaction.

13. The method of claim 12 wherein the identification of the participant to the interaction is obtained from a voice-analysis of the audio portion of the interaction.

14. The method of claim 10 wherein the bias-detecting profile is a global profile associated with a group of potential participants to the interaction.

15. The method of claim 10, further comprising:
classifying a video data of a second participant to the interaction; and
inputting at least a portion of the classified video data to the bias-detecting profile.

16. The method of claim 15 wherein the video data comprises data obtained via an eye tracking device of the participant device.

17. The method of claim 10 further comprising:
updating, based on feedback to the displayed bias-detection notification, the bias-detecting profile.

18. A tangible, non-transitory, computer-readable media having software encoded thereon, the software, when executed by a processor, operable to:
convert an audio portion of an interaction to a string of text data, the audio portion received from a participant device to the interaction;
obtain, based on receiving the audio portion from the participant device, a bias-detecting profile;
input at least a portion of the string of text data to the bias-detecting profile to receive an indication of a detected bias in the audio portion; and
transmit, to the participant device and based on the indication of the detected bias, a bias-detection notification for display by the participant device.

19. The tangible, non-transitory, computer-readable media of claim 18 further operable to:
select the bias-detecting profile from a plurality of profiles, wherein selecting the bias-detecting profile is based on an identification of the participant device to the interaction.

20. The tangible, non-transitory, computer-readable media of claim 18 further operable to:
classify a video data of a second participant to the interaction; and
input at least a portion of the classified video data to the bias-detecting profile, the indication of a detected bias further based on the classified video data.
